(19) United States
(12) Patent Application Publication
(10) Pub. No.: US 2012/0219067 A1
(43) Pub. Date: Aug. 30, 2012

(54) Transmitting A Video Signal

(76) Inventors: Andrei Jefremov, Janfalla (SE); David Zhao, Solna (SE); Sergey Sablin, Bromma (SE)

(21) Appl. No.: 13/295,737

(22) Filed: Nov. 14, 2011

(30) Foreign Application Priority Data
Feb. 24, 2011 (GB) 1103174.7

(51) Int. Cl. H04N 7/26

(52) U.S. Cl. 375/240.24; 375/240.01; 375/E07.026

(57) ABSTRACT

An encoder allocates index numbers to portions of a video signal transmitted over a network to a decoder. At least some of the portions are stored in an encoder buffer. Feedback is received from the network at a remote control block, indicating whether the transmitted portions are correctly received. Based on the feedback, the control block determines a subset of the portions stored in the buffer. The control block transmits a message to the encoder, identifying the subset using the index numbers allocated to the portions in the subset. In response, the encoder uses the index numbers to identify and retrieve at least one portion of the subset of portions from the buffer, the retrieved portion is used to encode subsequent portions of the signal.

### RELATED APPLICATION

This application claims priority under 35 U.S.C. §119 or 365 to Great Britain Application No. GB 1103174.7, filed Feb. 24, 2011. The entire teachings of the above application are incorporated herein by reference.

### TECHNICAL FIELD

The present invention relates to transmitting a video signal over a network. In particular the present invention relates to transmitting encoded portions of a video signal over a network.

### BACKGROUND

In order to transmit a video signal over a network, the video signal may be encoded in discrete portions. Each portion of the video signal may be a frame of the video signal. Alternatively, each portion of the video signal may be a macroblock of pixels (e.g. a 16×16 block of pixels) within a frame of the video signal or a “slice” of a frame of the video signal. A slice is a section of a frame of the video signal which can be encoded and decoded independently. Encoded portions of the video signal can be transmitted over a network to a receiver and decoded in order to recover the original video signal (or at least an approximation of the original video signal) at the receiver.

In a system in which the portions of the video signal to be encoded are frames of the video signal, the video signal may be coded using two types of video frames: intra-frames (also known as key frames) and inter-frames. A key frame is compressed (i.e. encoded) using only the current video frame (using intra-frame prediction), in a similar manner to that used in image coding. In contrast, an inter-frame is compressed (i.e. encoded) using knowledge of at least one decoded frame preceding (or following) the inter-frame in the video signal, and as such allows much more efficient compression of the video signal, particularly when the scene in the frame is similar to that in the at least one preceding (or following) frame. In order for a decoder to correctly decode an image using an inter-frame, the decoder must have received all frames on which the inter frame depends. If any of those frames have not been received at the decoder then the decoding of the current inter-frame will result in errors.

As such, frequent transmission of key frames is common in video streaming such that the decoder can recover lost information when packet loss occurs. In some alternative systems the receiver may request a key frame from the transmitter if packet loss is detected.

Key frames are large (and therefore require a large amount of bandwidth for transmission) relative to inter-frames and, as such, key frames may result in a poor quality frame. In order to address the problem of having to regularly transmit key frames, it is also known for some of the frames (e.g. reference frames) of the video signal to be stored at the decoder and at the encoder in order to reduce the number of key frames that are sent. In this case, recovery frames may be transmitted from the encoder to the decoder. Recovery frames are encoded using a stored reference frame that was sent earlier than the frame immediately preceding the recovery frame. Since the reference frames are stored both at the encoder and at the decoder, in the event that the decoder requests a recovery frame, the stored reference frame is used at the encoder to generate the recovery frame. The decoder can then correctly decode the recovery frame using the reference frame that is stored at the decoder.

However, there remains a problem in that if the most recent reference frame is lost in transmission between the encoder and the decoder then the decoder will not be able to correctly decode the recovery frame.

There are video compression technologies (such as VP7 and VP8) in which the network tracks the state of the decoder and makes “recovery” decisions as to how best to encode frames based on feedback received from the receiver relating to the success of the transmission of the frames. FIG. 1 shows a schematic diagram of a system 100 for implementing video compression according to VP7 or VP8. The system 100 comprises an encoder 102 and a remote interface 110. The encoder 102 comprises an encode block 104, a decode block 106 and a buffer 108. The encode block 104 of the encoder 102 is arranged to receive frames of an input video signal. The encode block 104 encodes the video frames to generate encoded video frames which are output from the encoder 102 for transmission to a receiver. The encoded video frames are also input to the decode block 106 where they are decoded and then stored in the buffer 108. The video frames stored in the buffer 108 may be passed to the encode block 104 for use in encoding subsequent frames of the video signal (e.g. for encoding inter-frames of the video signal). The interface 110 comprises a block 112 for receiving feedback from the network and for determining which of the frames transmitted to the receiver have been correctly received at the decoder of the receiver. The interface 110 also comprises a block 114 which receives the determination of which of the frames have been correctly received at the decoder of the receiver from block 112 and uses this information to determine a frame which has been correctly received at the decoder and which can therefore be used by the encode block 104 for encoding subsequent frames of the video signal.

The remote interface 110 can send an instruction to the encoder 102 to instruct the encoder 102 to store the next frame in a particular position in the buffer 108 (e.g. in position 1 in the buffer 108). This frame can then be used later for encoding subsequent frames of the video signal. If the remote interface 110 determines that the frame stored in the particular position in the buffer 108 has been correctly received at the decoder of the receiver then the block 114 sends a command to the encoder 102 to indicate that the frame stored in the particular position in the buffer 108 can be relied upon to encode subsequent frames of the video signal. The command sent from the interface 110 to the encoder 102 indicates the particular position in the reference frame buffer 108 of the frame. The encoder 102 then retrieves the frame at the particular position from the buffer 108 for use in generating subsequent frames because the encoder 102 can be confident that the frame at the particular position of the buffer 108 was correctly received at the decoder.

However, there are problems with the system 100 of VP7 and VP8. For example, the size of the reference frame buffer 108 in the encoder 102 is limited to store only the previous frame and two more frames (e.g. at particular positions). This significantly limits the number of possible frames which can be used for generating subsequent frames of the video signal. Furthermore, since the interface 110 is remote from the encoder 102 there may be a delay between sending the command from the interface 110 and receiving the command at the encoder 102 which can detrimentally affect the quality of the encoding performed by the encoder 102.

### SUMMARY

According to a first aspect of the invention there is provided a method of transmitting a video signal over a network, the method comprising: encoding portions of the video signal with an encoder, and transmitting the encoded portions over the network to a decoder; the encoder allocating index numbers to the transmitted portions of the video signal, each index number identifying a respective portion of the video signal; storing at least some of the portions of the video signal in a buffer associated with the encoder; receiving feedback from the network at a control block remote from the encoder, the feedback indicating whether each of the transmitted portions has been correctly received; based on the feedback, the control block determining a subset of the portions of the video signal stored in the buffer which are to be used by the encoder for encoding subsequent portions of the video signal; the control block transmitting a message to the encoder, said message identifying the subset of portions of the video signal using the index numbers allocated to the portions in the subset of portions; and in response to receiving the message from the control block, the encoder using the index numbers in the message to identify and retrieve at least one portion of the subset of portions from the buffer, wherein the encoder encodes subsequent portions of the video signal using the at least one retrieved portion.

The portions of the video signal may be, for example, frames, macroblocks or slices of the video signal. Advantageously, since the index numbers are allocated to the portions of the video signal (rather than to positions in the buffer), the index numbers identify specific portions of the video signal (e.g. specific frames). This means that portions of the video signal stored in the buffer can be identified using their respective index numbers even if the portions are subsequently moved from their original position in the buffer. This is particularly useful because the control block is remote from the encoder and as such there may be a delay between transmitting the message from the control block and the encoder receiving the message. By using index numbers which identify the portions (e.g. frames) of the video signal, rather than identifying a position in the buffer, the control block can reliably identify the subset of portions which are to be used by the encoder for encoding subsequent portions of the video signal. Therefore, in preferred embodiments, the index numbers allow the encoder to uniquely identify which frame is identified by a particular index number.

Preferably, the index numbers allocated to the portions within a time interval equal to the average Round Trip Time between the encoder and the decoder, are unique.

A frame may be identified at the encoder as a frame to be saved for future reference, such that the frame will not be removed from the buffer without explicit action from the encoder. With an H.264 encoder this can be achieved by marking the frame as a “long term reference” frame. With a VP8 encoder this can be achieved by marking the frame as a “golden” or an “alternative” frame. Other types of encoders may achieve this in different ways.

According to a second aspect of the invention there is provided a system for transmitting a video signal over a network, the system comprising: (i) an encoder which is configured to: encode portions of the video signal, and transmit the encoded portions over the network to a decoder; allocate index numbers to the transmitted portions of the video signal, each index number identifying a respective portion of the video signal; and store at least some of the portions of the video signal in a buffer associated with the encoder; and (ii) a control block which is remote from the encoder and which is configured to: receive feedback from the network, the feedback indicating whether each of the transmitted portions has been correctly received; determine, based on the feedback, a subset of the portions of the video signal stored in the buffer which are to be used by the encoder for encoding subsequent portions of the video signal; and transmit a message to the encoder, said message identifying the subset of portions of the video signal using the index numbers allocated to the portions in the subset of portions, wherein the encoder is configured to identify and retrieve, in response to receiving the message from the control block, at least one portion of the subset of portions from the buffer using the index numbers in the message, and to encode subsequent portions of the video signal using the at least one retrieved portion.

There may be a network connection or a USB connection between the encoder and the control block for transmitting the message from the control block to the encoder. The encoder may be a H.264 encoder.

According to a third aspect of the invention there is provided a method of controlling transmission of portions of a video signal which are encoded by an encoder and transmitted over a network to a decoder, wherein the encoder allocates index numbers to the transmitted portions of the video signal and stores at least some of the portions of the video signal in a buffer associated with the encoder, each index number identifying a respective portion of the video signal, the method comprising: receiving feedback from the network at a control block remote from the encoder, the feedback indicating whether each of the transmitted portions has been correctly received; based on the feedback, the control block determining a subset of the portions of the video signal stored in the buffer which are to be used by the encoder for encoding subsequent portions of the video signal; and the control block transmitting a message to the encoder, said message identifying the subset of portions of the video signal using the index numbers allocated to the portions in the subset of portions, such that the encoder can use the index numbers in the message to identify at least one portion of the subset of portions for encoding subsequent portions of the video signal.

According to a fourth aspect of the invention there is provided a computer program product comprising computer readable instructions for execution by computer processing means at a control block for controlling transmission of portions of a video signal, the instructions comprising instructions for carrying out the method according to the third aspect of the invention.

According to a fifth aspect of the invention there is provided a control block for controlling transmission of portions of a video signal which are encoded by an encoder and transmitted over a network to a decoder, wherein the encoder allocates index numbers to the transmitted portions of the video signal and stores at least some of the portions of the video signal in a buffer associated with the encoder, each index number identifying a respective portion of the video signal, wherein the control block is remote from the encoder and the control block comprises: receiving means for receiving feedback from the network, the feedback indicating whether each of the transmitted portions has been correctly received; determining means for determining, based on the feedback, a subset of the portions of the video signal stored in the buffer which are to be used by the encoder for encoding subsequent portions of the video signal; and transmitting means for transmitting a message to the encoder, said message identifying the subset of portions of the video signal using the index numbers allocated to the portions in the subset of portions, such that the encoder can use the index numbers in the message to identify at least one portion of the subset of portions for encoding subsequent portions of the video signal.

### BRIEF DESCRIPTION OF THE DRAWINGS

For a better understanding of the present invention and to show how the same may be put into effect, reference will now be made, by way of example, to the following drawings in which:

FIG. 1 shows a schematic diagram of a prior art system for implementing video compression;

FIG. 2 shows a system for transmitting a video signal over a network according to a preferred embodiment;

FIG. 3 shows a first sequence of video frames in a video signal;

FIG. 4 shows a second sequence of video frames in a video signal;

FIG. 5 is a graph representing the amount of data required to encode video frames using different types of encoding technique;

FIG. 6 shows a representation of how error propagates over time in the case of packet loss for a sequence of inter encoded frames, in a system which does not employ recovery frames;

FIG. 7 shows a representation of how error propagates over time in the case of packet loss for a sequence of inter encoded frames, in a system which does employ recovery frames; and

FIG. 8 is a flow chart for a process of transmitting a video signal over a network in accordance with a preferred embodiment.

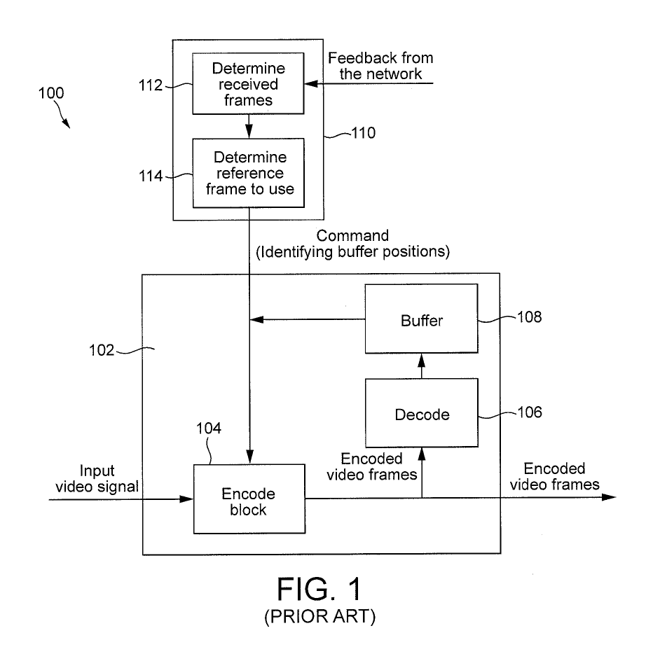

### DETAILED DESCRIPTION

Preferred embodiments of the invention will now be described by way of example only.

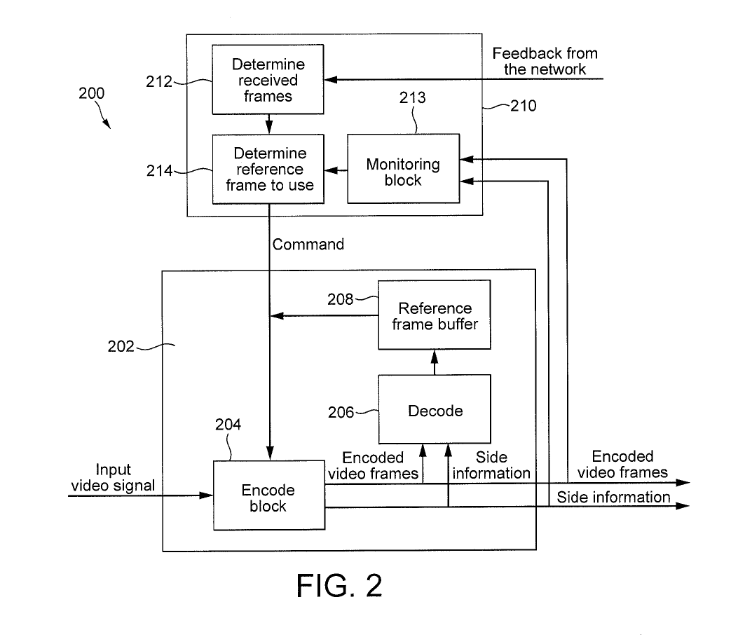

With reference to FIG. 2 there is described a system 200 for transmitting a video signal over a network according to a preferred embodiment. The system is used to stream a video signal over the network. The system 200 comprises an encoder 202 and a remote interface (or “control block”) 210. The encoder is an H.264 encoder. In alternative embodiments, the encoder could be any other type of video encoder which can refer to previous frames of the video signal for encoding a current frame of the video signal (such as a VP7 or VP8 encoder). The encoder 202 comprises an encode block 204, a decode block 206 and a reference frame buffer 208. The encode block 204 of the encoder 202 is arranged to receive frames of an input video signal. The encode block 204 is arranged to encode the video frames to generate encoded video frames and side information which are output from the encoder 202 for transmission from the encoder 202. The encoded video frames may be transmitted over the network to a receiver, and may also be transmitted to the control block 210. The side information may (or may not) be transmitted with the encoded video frames over the network to the receiver and/or may (or may not) be transmitted to the network and/or to the control block 210. The encode block 204 is arranged to input the encoded video frames and side information to the decode block 206. An output of the decode block 206 is coupled to the reference frame buffer 208. The decode block 206 is arranged to decode the frames output from the encode block 204 and pass the decoded frames to the reference frame buffer 208. The reference frame buffer 208 is arranged to store at least some of the decoded frames. The reference frame buffer 208 is arranged to pass video frames stored therein to the encode block 204 for use in encoding subsequent frames of the video signal (e.g. for encoding inter-frames of the video signal). The control block 210 comprises a receive block 212 arranged to receive feedback from the network and to determine which of the frames transmitted to the receiver have been correctly received at the decoder of the receiver. The control block 210 also comprises a monitoring block 213 for receiving the transmitted frames and side information from the encoder 202. The control block 210 also comprises a decision block 214 which receives: (i) from receive block 212, the determination of which of the frames have been correctly received at the decoder of the receiver, and (ii) an output signal from the monitoring block 213, and uses this information to determine at least one reference frame which has been correctly received at the decoder and which can therefore be used by the encode block 204 for encoding subsequent frames of the video signal.

The control block 210 is remote from the encoder 202. In other words, the connection between the encoder 202 and the control block 210 uses an external interface, such as (i) an interface to communicate over a network such as the Internet (where the control block 210 is implemented on a different network node, to the network node at which the encoder is implemented) or (ii) an interface between a host device and a peripheral device connected to the host device (for example, where the encoder is implemented in a camera and the control block is implemented in a user terminal, the connection between the control block 210 and the encoder 202 may be a USB connection). To put it another way, the control block 210 is remote from the encoder 202 in the sense that the control block 210 is outside of the encoder code. Furthermore, the control block 210 may be implemented at a single node, or over multiple nodes. For example, the receive block 212, monitoring block 213 and decision block 214 may be implemented at different network nodes. Different CPUs may be used by the receive block 212, the monitoring block 213 and the decision block 214. Although the monitoring block 213 is shown as receiving both the side information and the encoded frames, in other embodiments, the monitoring block may receive one or none of the side information and the encoded frames from the encoder 202.

The decision block 214 is arranged to send commands to the encoder 202 to indicate that one, or more, of the reference frames stored in the reference frame buffer 208 has been correctly decoded at the receiver and can be relied upon to encode subsequent frames of the video signal.

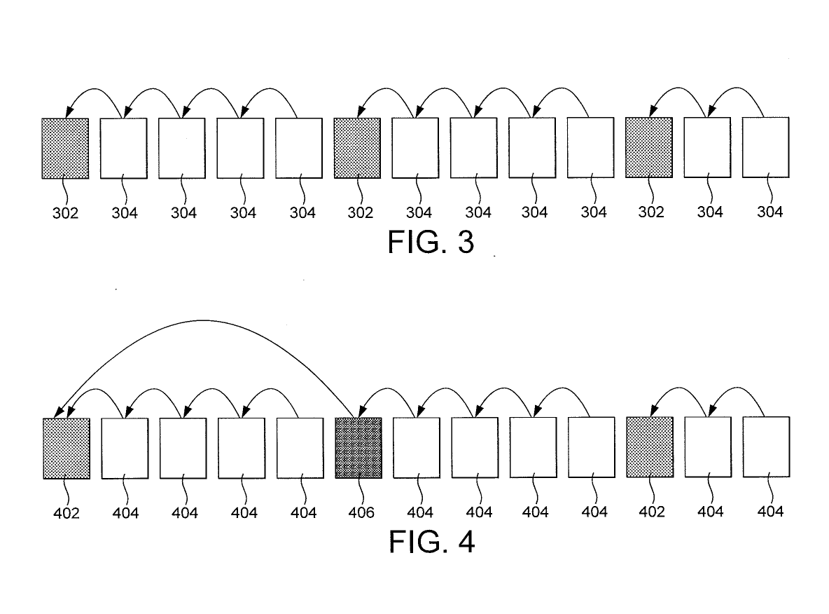

As described above, some video frames may be encoded as inter frames meaning that they are encoded as a difference between the current frame and one (or more) of previous frames. Other video frames (called intra frames or key frames), may be encoded without reference to any other frames of the video signal. FIG. 3 shows a sequence of video frames in which the shaded frames 302 are intra-frames and the unshaded frames 304 are inter-encoded frames. The arrows show how the encoding of each inter frame 304 is dependent upon the previous frames of the video signal back to the most recently encoded key frame 302.

The use of inter-encoded frames allows the system to compress a typical video signal with great efficiency. However, the problem with such coding methodology in the real time communication over lossy links (or on links with high delay in the Transmission Control Protocol (TCP) case) is that losing any of the frames/portions of the video signal would usually cause errors in the decoding process of each frame until the next key frame is present in the video stream.

One solution to this problem is to use so called “Recovery frames”. FIG. 4 shows a sequence of video frames in a video signal, similar to that shown in FIG. 3. Frames 402 are key frames, frames 404 are inter-encoded frames and frame 406 is a recovery frame. The arrow from the recovery frame 406 to the first key frame 402 indicates that the recovery frame 406 is encoded based on some frame from the past (in this case, the first key frame 402) rather than being encoded on the immediately preceding inter frame. As a result any frame between the first key frame 402 and the recovery frame 406 can be lost on the transmission connection, but the received Recovery frame 406 will be decodable based on the first key frame 402. Furthermore, the inter frames following the recovery frame 406 are decodable based on the correctly decoded recovery frame 406.

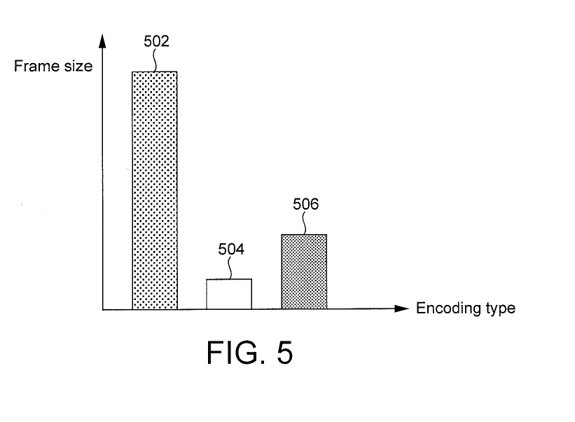

Recovery frames, which are encoded based on a previous frame in the video stream, are usually more efficient to encode than key frames are to encode. FIG. 5 shows a graph representing typical amounts of data required to encode video frames using the different types of encoding technique described above. It can be seen from FIG. 5 that a key frame 502 requires more data than a recovery frame 506, which itself requires more data than an inter frame 504 to encode. FIG. 5 demonstrates that generating a key frame is most expensive, followed by a recovery frame and followed by “normal”, inter frames. Indeed, in general, it is advantageous to use as much information about previous frames as possible to increase coding efficiency, error protection and reduce jitter. Although FIG. 5 represents typical amounts of data (for a typical video signal) in the frames according to the encoding technique used, the amount of data in a frame also depends upon the content of the video signal. For example, for purely random video signal the size of frames encoded with each encoding technique would be very similar to each other. For purely static video signals (i.e. in which a whole sequence of consecutive frames have the same image) the recovery and inter frames may have the same size.

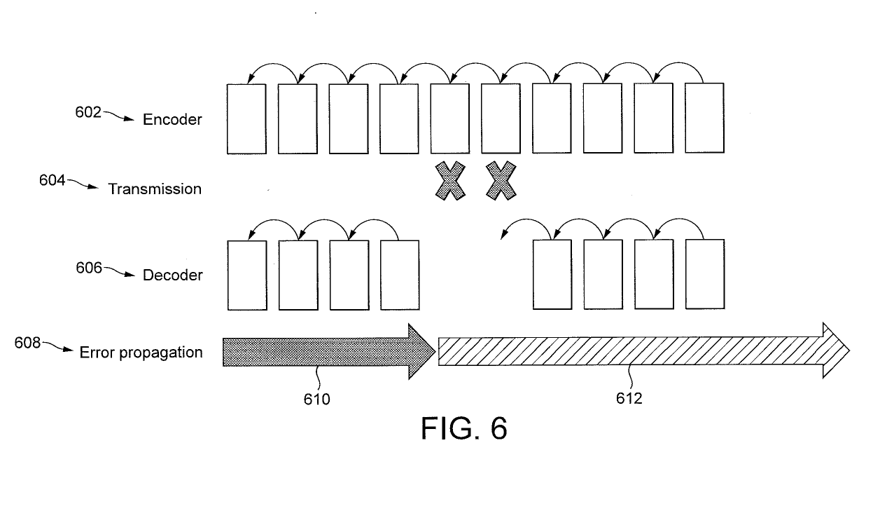

FIG. 6 shows a representation of how error propagates over time in the case of packet loss for a sequence of inter encoded frames, in a system which does not employ recovery frames. All of the frames shown in FIG. 6 are inter frames. FIG. 6 shows that an encoder generates a sequence of inter frames 602. These frames are transmitted over a network to a decoder at a receiver. During transmission two of the inter frames transmitted from the encoder are lost or corrupted beyond repair. This is shown in line 604 of FIG. 6. Line 606 of FIG. 6 shows that the decoder has received all but the lost two of the video frames transmitted from the encoder. Line 608 of FIG. 6 shows the error propagation through the sequence of inter frames of the video signal decoded at the decoder. The first arrow 610 indicates that there is no (or minimal) error in the first four decoded frames. However, the arrow 612 indicates, that there is significant error in the decoded video stream starting from the fifth frame and continuing through all subsequent frames shown in FIG. 6. Although only the fifth and sixth frames are lost during the transmission, the seventh to tenth frames rely on the fifth and sixth frames of the video sequence in order to be correctly decoded. The error will continue to propagate in each subsequent frame of the video signal until the next key frame is transmitted from the encoder.

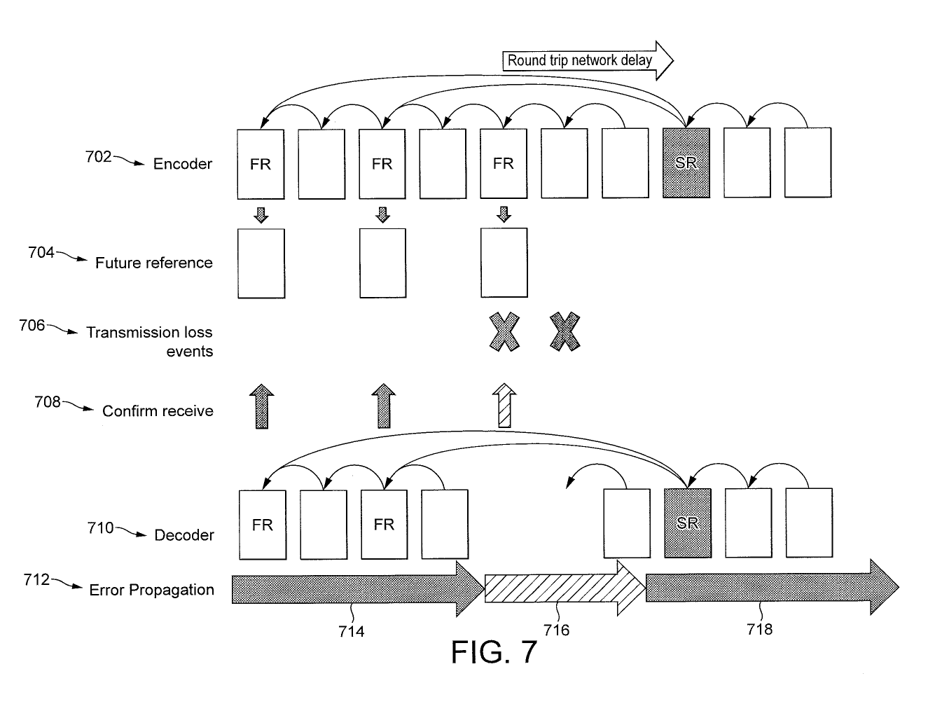

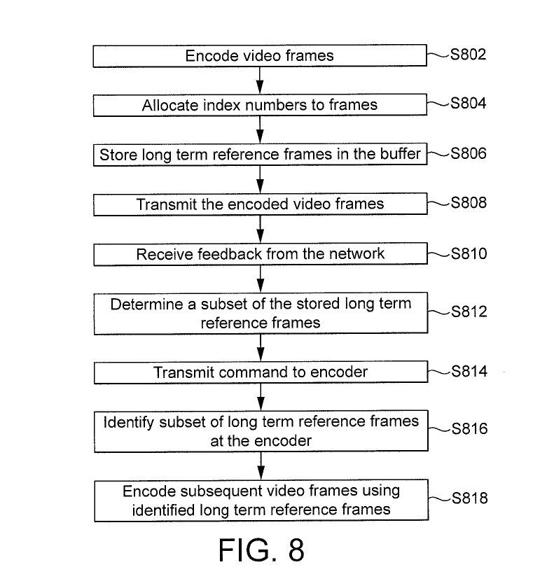

FIG. 7 shows a representation of how error propagates over time in the case of packet loss for a sequence of inter encoded frames, in a system which does employ recovery frames, such as the system 200 of a preferred embodiment shown in FIG. 2. A method for transmitting a video signal over a network in accordance with preferred embodiments is described below with reference to the flow chart shown in FIG. 8 and in conjunction with FIGS. 2 and 7.

In step S802 the encode block 204 of the encoder 202 encodes video frames of the input video signal. The particular method used to encode the video frames may vary from frame to frame as described in more detail below. In step S804 the encode block 204 allocates an index number to each frame of the video signal. The index numbers allow each frame of the video signal to be identified. The encode block 204 also generates side information to accompany the encoded video frames. The side information simplifies the packetisation and handling of the video frames during transmission of the video frames over the network to a decoder at a receiver. The side information may, or may not, include the index numbers allocated to the video frames. The side information may indicate how a particular frame has been encoded (e.g. the encoding method used, and which other frames of the video signal were used by the encoder 202 to encode the current frame.

The encoded video frames are passed to the decode block 206 where they are decoded. The output of the decode block 206 should be the same as the output of the decoder at the receiver, assuming all of the video frames are successfully transmitted across the network to the receiver. By basing the encoding of subsequent frames of the video signal on the output of the decode block 206 the encode block 204 can accurately encode frames of the video signal in such a way that will be correctly decoded at the decoder at the receiver (assuming that no transmission errors occur).

Some of the frames of the video signal are designated as long term reference frames (or Future Reference frames, denoted “FR” in FIG. 7). In step S806 the designated long term reference frames are stored in the reference frame buffer 208 for later use in generating subsequent frames of the video signal at the encoder 202. FIG. 7 shows that alternate frames of the video signal have been designated as long term reference frames for storage in the long term reference buffer 208 (as indicated in line 704 of FIG. 7). In other embodiments, different ones of the video frames may be designated as long term reference frames. For example, one in every three, or one in every four, frames may be a long term reference frame, and as such may be stored in the long term reference buffer 208 for subsequent use by the encode block 204. The side information transmitted with the encoded frames may indicate which of the frames are long term reference frames, such that the decoder at the receiver will know to store those frames in a long term reference buffer at the decoder for subsequent use in decoding frames of the video signal which have been encoded based on the long term reference frames (as described in more detail below).

In step S808 the encoded frames of the video signal and possibly the side information are transmitted from the encoder 202 to the decoder at the receiver over the network. The side information may, or may not, be transmitted to the decoder of the receiver. The side information may not be needed for the decoding process at the receiver. The side information allows a more efficient handling of the video stream on the network level. The side information may be provided to the monitoring block 213 of the control block 210 as shown in FIG. 2. The side information may include one or more of the following pieces of information:
(i) the index number allocated to the frame that is currently being transmitted with the side information. As an alternative to including this information in the side information, the encoder 202 and the control block 210 can agree on a frame numbering strategy and can each independently allocate index numbers to the frames according to the same algorithm (e.g. increase index number by one for each frame, or a timer could be used to generate the index numbers. These methods may encounter problems if a frame is lost or delayed between the encoder 202 and the controller 210, and the numbering may become out of sync.
(ii) an indication as to whether the frame was saved in reference frame buffer 208. Preferably, the indication may indicate the position in the buffer 208 at which the frame is stored. This information may be able to be read from slice headers with the encoded frames, but by including this information in the side information, the process by which the control block 210 can determine this information is simplified.
(iii) the subset of frames which are used to encode the current frame. It can be useful for the control block 210 to know this information since it will give an indication of whether the video stream has been recovered or not. This information can be read from the bitstream, but it may be computationally expensive to retrieve this information from the bitstream. Therefore by including this information in the side information the computation required at the control block 210 can be reduced.

It can therefore be appreciated that the use of the side information has the advantage that control block 210 can be implemented more simply since it does not have to parse the bitstream to retrieve the information in the side information. The control block 210 may be implemented independently of the encoder. The term “independent” in this context means that the same control block 210 can be used to control several different encoders. This can be useful in software development since it reduces the amount of code needed. Assuming that the side information is agreed between the encoder implementations, control blocks can be identical for use with different encoders. If the side information is different for different encoders, or if the information is obtained from the bitstream rather than from side information, then only the monitoring block 213 needs to be developed in an encoder specific fashion. If the side information is transmitted to the decoder then this provides a mechanism for the decoder to know whether the video stream is decoded correctly.

However, in the example shown in FIG. 7, two of the frames of the video signal are not successfully transmitted over the network to the decoder, as shown in line 706.

The decoder at the receiver sends feedback messages over the network to acknowledge the receipt of the video frames. In step S810 these feedback messages are received at the control block 210. The receive block 212 of the control block 210 determines, from the feedback, which of the video frames transmitted from the encoder 202 have been successfully received at the decoder of the receiver. This information is passed to the decision block 214 of the control block 210. In step S812 the decision block 214 determines a subset of the long term reference frames stored in the reference frame buffer 208 which have been correctly received at the decoder of the receiver. The subset of the stored long term reference frames identifies those long term reference frames which can be used validly by the encoder 202 to encode subsequent frames of the video signal.

In step S814 a command (or “message”) is transmitted from the decision block 214 of the control block 210 to the encoder 202 to indicate the subset of long term reference frames which can be used by the encode block 204 for encoding subsequent frames of the video signal. The subset may identify one or multiple long term reference frames.

In step S816 the encoder identifies the frames in the subset which are indicated in the command. The command identifies the frames in the subset using the index numbers of the frames. In this way it is the frames themselves which are indicated, rather than their position in the reference frame buffer 208.

In step S818 the encode block 204 retrieves at least one suitable long term reference frame from the reference frame buffer 208 in accordance with the frames identified in the command, and then encodes at least one subsequent frame of the video signal using the retrieved long term reference frame(s). By basing the encoding of subsequent frames of the video signal on long term reference frame(s) that are identified in the command, the encoder can be sure to encode subsequent frames using previous frames that have been received correctly at the decoder of the receiver.

As shown in FIG. 7, the receiver acknowledges that the first two reference frames are correctly received at the decoder of the receiver. However, when a frame is lost during transmission over the network then the feedback from the decoder to the control block 210 indicates that the frames have not been correctly received at the decoder. The time between a frame being transmitted from the encoder 202 and the feedback for that frame being received at the control block 210 is approximately equal to the Round Trip Time (RTT) (denoted “Round Trip Network Delay” in FIG. 7). The RTT is typically longer than the duration of a frame of the video signal (when the frame is played out). In this case, the control block 210 does not determine that a frame has been lost before the next frame of the video signal is encoded and transmitted. However, for the first frame after the control block 210 determines that a frame has been lost during transmission, the control block 210 determines that a Stream Recovery frame (denoted “SR” in FIG. 7) is to be generated. In this case, the command sent from the control block 210 to the encoder 202 includes the index numbers indicating the first two (correctly received) long term reference frames, such that the Stream Recovery frame is encoded based on the first two long term reference frames by the encode block 204 of the encoder 202. Therefore, the Stream Recovery frame can be correctly decoded at the decoder of the receiver (based on the first two correctly received long term reference frames—which have been stored at a buffer of the decoder in the receiver).

The line 712 in FIG. 7 shows the error propagation through the video signal at the decoder. The first four frames are correctly received and can be decoded (as indicated by arrow 714). The next two frames are not received at the decoder and as such cannot be decoded. The following frame also cannot be correctly decoded at the decoder because it was encoded at the encoder based on at least one of the preceding frames that was lost in transmission. Arrow 716 indicates that errors propagate through these three frames of the video signal. However, the Stream Recovery frame is then received at the decoder which was encoded based on the correctly received long term reference frames. The decoder can retrieve the correctly received long term reference frames from a buffer associated with the decoder and can correctly decode the Stream Recovery frame. The frames subsequent to the Stream Recovery frame can be correctly decoded because they are encoded based on the correctly received and decoded Stream Reference frame. Arrow 718 indicates that little or no error propagates through the frames subsequent to the Stream Recovery frame in the video signal.

As can be seen from the above description the long term reference frames (“FR”) are frames which are saved in the encoder memory (e.g. in reference frame buffer 208) and in the decoder memory for future reference. The Stream Recovery frame (“SR”) is a frame which, based on the current network conditions, can perfectly recover the video stream.

The control block 210 acts as an encoder Application Programming Interface (API) for the encoder 202 which reports to the encoder 202 which frames can be used reliably as reference frames in the event of a packet loss. The control block 210 makes the decision (in the decision block 214) as to which long term reference frames should be used to encode subsequent frames based on the feedback received from the network regarding the success of the transmission of previous frames of the video signal. The control block 210 then simply tells the encoder 202 which long term reference frames to use for encoding subsequent frames of the video signal. Therefore, the encoder 202 does not need to be able to perform such a decision. This means that the encoder 202 can be simplified. It can be advantageous to implement the encoder 202 in a simple manner. In particular, the control block 210 can be used to provide the commands to any suitable type of encoder, such as an H.264 encoder, a VP8 or VP7 encoder. The use of side information as described above can simplify the implementation of the control block 210 making it less CPU intensive. The control block 210 maintains the state of the decoder buffer in order to determine how best to encode subsequent frames of the video signal.

In one embodiment, the encoder 202 is implemented in a camera which is connected to a user terminal on which the control block 210 is implemented. In this embodiment the transmission of the encoded frames of the video signal can be transmitted from the encoder 202 to the network via the user terminal on which the control block 210 is implemented.

In another embodiment, the encoder 202 is implemented at a user terminal and the control block 210 is implemented at another node in the network (e.g. at a server node of the network or at the receiver node at which the decoder is implemented). By having the control block 210 remote from the encoder 202 the processing resources used to implement the encoder 202 and the control block 210 are advantageously separated from each other.

Furthermore, since the control block 210 makes the decisions as to which long term reference frames to base the encoding of subsequent frames on, the design and implementation of the encoder 202 can be simplified. For example, where the encoder is a H.264 encoder, the encoder may not have the notion of recovery frames, as described above. However, according to the H.264 standard, an H.264 encoder does have the ability to refer and store up to sixteen frames in the local memory, thereby allowing the control block 210 to be implemented in conjunction with a H.264 encoder as described above.

The method and system described above advantageously uses index numbers which identify frames (rather than buffer positions as in VP7 or VP8 described in the background section above). This enables the system to handle asynchronous modes of operation, which are typical for hardware encoders (e.g. where the encoder 202 is in a peripheral device and the control block 210 is in a user terminal) and remote systems (e.g. where the encoder 202 and control block are implemented at different network nodes, such as a server controlled remote encoder—for example where the encoder is implemented in a web browser plug-in—or a receiver controlled encoder where the control block is implemented at the receiver). These are considered to be asynchronous modes of operation because the time taken for the command to be transmitted from the control block 210 to the encoder 202 is longer than the time duration of a frame of the video signal during play out. Therefore, when the command is generated by the control block 210, the control block 210 cannot know what the contents of the reference frame buffer 208 will be when the command is received at the encoder 202. This could cause a problem if the buffer positions in the reference frame buffer 208 were used rather than the index numbers which identify the frames themselves.

The index numbers identify the frames in terms of absolute numbers. The term “absolute” here means that the modulo of the index number is larger than RTT/T_{f}, where T_{f} is the duration of a frame of the video signal when it is played out. In this sense the index number will not repeat for frames generated within the Round Trip Time of the transmission of the encoded frames. Preferably the modulo of the index number is much larger than RTT/T_{f} to account for extraordinary losses and delays in the network. The index number could be used only inside the encoder 202 and does not have to be part of the bitstream, thereby maintaining compatibility with standard decoders. The index number could grow with each encoded frame. The encoder could be asked to use some “sensible” number of bits for frame identification. For example, the encoder may be an H.264 encoder and the minimum number of bits used in H.264 is 4 bits, such that a sequence of 16 frames have unique index numbers but after that the index numbers cycle and repeat for every 16 frames. This repetition of index number may be known as wrapping. If 8 bits are used for the index number we can have a sequence of 256 frames having unique index numbers. At 30 frames per second, this would represent a time of 8.5 seconds before the index numbers start to repeat. 8.5 seconds is much larger than the RTT in most communications, and as such using 8 bits for the index number of the frames is sufficient for treating the index numbers as being absolute (i.e. unique for frames within a time duration of the average RTT). It should be ensured that the wrap period of the index numbers is much longer than the typical RTT, such that the index numbers can be considered to be absolute (i.e. unique within the average RTT). In this sense, the index numbers provide a unique way of identifying a frame in the control block 210. The index numbers may be used only for communications between the control block 210 and the encoder 202, such that within the encoder 202 itself, a frame may be identified by some other identification method after the control block 210 has uniquely identified the frame to the encoder 202 using the index numbers described herein.

There is presented below an example to highlight the advantage of using index numbers that identify specific frames rather than using buffer positions to identify frames. Let us assume that the encoder 202 puts Frame X into position N in the reference frame buffer 208. Addressing the frame by X (rather than by N) gives unique mapping between frames (within counter X wrap time) and is therefore more robust, particularly in cases where there is a large delay (in time) for messages transmitted between the control block 210 and the encoder 202, or where there is a chance that commands sent from the control block 210 may actually be received at the encoder 202 in a different order, for example when the control block 210 is implemented on a server of the network or on the receiver.

Let us assume that the control block issues Command 0 which instructs the encoder 202 to recover the video stream using frame X (which is currently stored at position N in the reference frame buffer 208), and then issues Command 1 which instructs the encoder 202 to put a current frame (Y) into position N of the reference frame buffer. Then let us assume that Command 0 is delayed in the network such that Command 1 is received at the encoder 202 before Command 0. In embodiments of the present invention the encoder 202 realizes that frame X is not present in the reference frame buffer 208 when Command 0 is received at the encoder 202, and can then deal with the situation accordingly. For example, the encoder 202 may determine that a key frame must be generated, or may determine some other way of encoding the current frame using frames which are still present in the reference frame buffer 208.

However, if this same situation occurred in a system in which the commands sent from the control block to the encoder identified positions in the reference frame buffer, rather than the absolute index numbers identifying frames of the preferred embodiments described above, then the encoder would try to recover the video stream using frame Y rather than frame X because frame Y would be in position N in the reference frame buffer when Command 0 was received at the encoder instructing the encoder to recover the video stream using the frame at position N in the reference frame buffer. This will most likely result in a broken video stream which may be difficult to recover from without resorting to generating a key frame (which as described above in relation to FIG. 5 is costly in terms of the amount of data required to store and transmit the frame).

The control block 210 should be able to determine which of the transmitted frames of the video signal are stored in the reference frame buffer 208 at the encoder 202. In order to achieve this, the encoder 202 may send a message to the control block 210 to inform the control block 210 of which frames are stored in the reference frame buffer 208. Alternatively, all of the frames marked as long term reference frames are stored in the reference frame buffer 208, and the control block 210 monitors the transmitted frames and the side information to determine which frames are long term reference frames and are therefore stored in the reference frame buffer 208.

In summary of the above, embodiments of the present invention provide a system by which reference frames can be identified using “absolute”, or “unique”, index numbers. This is in contrast to the systems of the prior art which identify positions in the buffer. The production of side information by the encoder 202, aids the control block 210 (but not necessarily the decoder of the receiver) in identifying which frames need to be correctly received for the current frame to be decoded correctly (essentially a set of frames that the current frame is coded in dependence on). The control block 210 is external (or “remote”) from the encoder 202 thereby separating the decision making process from the encoder 202.

As described above, the index numbers of the frames may be transmitted in the side information with the transmitted frames to the receiver. Alternatively, instead of transmitting the index numbers, the system can make use of the Real-time Transport Protocol (RTP) to carefully monitor the feedback from the network which is sent as control signals using Real-time Transport Control Protocol (RTCP). In this way the control block 210 can keep track of the index numbers that the encoder will allocate to each frame (assuming the control block 210 uses the same numbering system as the encoder 202 uses for determining index numbers for the frames).

When the control block 210 can determine the index numbers allocated to the frames then the control block 210 can determine, from the feedback, the subset of the index numbers of the long term reference frames which have been successfully received at the decoder of the receiver, as described above.

Although in the preferred embodiments described above the method and system are applied to frames of the video signal, in other embodiments, the method and system are applied to other portions of the video signal such as slices or macroblocks.

Although in the preferred embodiments described above it is the long term reference frames which are stored in the reference frame buffer 208, in other embodiments, other types of frames (e.g. short term reference frames) may be stored for use in generating subsequent frames of the video signal. Short term reference frames will be removed from the buffer in an automatic fashion according to certain predefined rules.

The system of the preferred embodiments described above is used to stream a video signal over the network from the encoder to the decoder at the receiver. In this sense, the video frames may be played out at the receiver in real-time as they are decoded. If the video signal is not being played out in real-time as it is received then the decoder can request that the encoder re-transmits any frames that are lost or corrupted during transmission of the video signal over the network.

The blocks shown in FIG. 2 and the method steps shown in FIG. 8 may be implemented in software or hardware modules within the encoder 202 and the control block 210. This is an implementation choice.

It should be understood that the block, flow, and network diagrams may include more or fewer elements, be arranged differently, or be represented differently. It should be understood that implementation may dictate the block, flow, and network diagrams and the number of block, flow, and network diagrams illustrating the execution of embodiments of the invention.

It should be understood that elements of the block, flow, and network diagrams described above may be implemented in software, hardware, or firmware. In addition, the elements of the block, flow, and network diagrams described above may be combined or divided in any manner in software, hardware, or firmware. If implemented in software, the software may be written in any language that can support the embodiments disclosed herein. The software may be stored on any form of non-transitory computer readable medium, such as random access memory (RAM), read only memory (ROM), compact disk read only memory (CD-ROM), flash memory, hard drive, and so forth. In operation, a general purpose or application specific processor loads and executes the software in a manner well understood in the art.

Furthermore, while this invention has been particularly shown and described with reference to preferred embodiments, it will be understood to those skilled in the art that various changes in form and detail may be made without departing from the scope of the invention as defined by the appendant claims.

What is claimed is:

1. A method of transmitting a video signal over a network, the method comprising:
encoding portions of the video signal with an encoder, and transmitting the encoded portions over the network to a decoder;
the encoder allocating index numbers to the transmitted portions of the video signal, each index number identifying a respective portion of the video signal;
storing at least some of the portions of the video signal in a buffer associated with the encoder;
receiving feedback from the network at a control block remote from the encoder, the feedback indicating whether each of the transmitted portions has been correctly received;
based on the feedback, the control block determining a subset of the portions of the video signal stored in the buffer which are to be used by the encoder for encoding subsequent portions of the video signal;
the control block transmitting a message to the encoder, said message identifying the subset of portions of the video signal using the index numbers allocated to the portions in the subset of portions; and
in response to receiving the message from the control block, the encoder using the index numbers in the message to identify and retrieve at least one portion of the subset of portions from the buffer, wherein the encoder encodes subsequent portions of the video signal using the at least one retrieved portion.

2. The method of claim 1 wherein the portions of the video signal are (i) frames of the video signal, (ii) macroblocks of the video signal, or (iii) slices of the video signal.

3. The method of claim 1 wherein one of the subsequent portions of the video signal which are encoded using the at least one retrieved portion, is a recovery portion of the video signal which is encoded based only on the at least one retrieved portion.

4. The method of claim 1 wherein the index numbers allocated to the portions within a time interval equal to the average Round Trip Time between the encoder and the decoder, are unique.

5. The method of claim 1 further comprising the encoder informing the control block of which portions of the video signal are stored in the buffer.

6. The method of claim 1 wherein the portions of the video signal are stored in the buffer if they are of a particular type, and wherein the method further comprises the control block monitoring the transmitted portions of the video signal and determining that those portions of the video signal which are of the particular type are stored in the buffer.

7. The method of claim 1 wherein the portions of the video signal which are stored in the buffer are long term reference portions of the video signal.

8. The method of claim 1 wherein the index numbers are transmitted with the portions of the video signal to which they are allocated.

9. The method of claim 8 wherein the index numbers are transmitted as side information accompanying the transmitted portions of the video signal to which they are allocated.

10. The method of claim 1 wherein the index numbers are not transmitted with the portions of the video signal to which they are allocated, and wherein the control block monitors the transmission of the portions of the video signal and uses the monitoring of the transmission of the portions of the video signal to thereby determine the index numbers which have been allocated to the transmitted portions of the video signal.

11. The method of claim 1 wherein the step of the control block transmitting the message to the encoder comprises transmitting the message over one of a network connection and a USB connection.

12. A system for transmitting a video signal over a network, the system comprising:
(i) an encoder which is configured to:
encode portions of the video signal, and transmit the encoded portions over the network to a decoder;
allocate index numbers to the transmitted portions of the video signal, each index number identifying a respective portion of the video signal; and
store at least some of the portions of the video signal in a buffer associated with the encoder; and
(ii) a control block which is remote from the encoder and which is configured to:
receive feedback from the network, the feedback indicating whether each of the transmitted portions has been correctly received;
determine, based on the feedback, a subset of the portions of the video signal stored in the buffer which are to be used by the encoder for encoding subsequent portions of the video signal; and
transmit a message to the encoder, said message identifying the subset of portions of the video signal using the index numbers allocated to the portions in the subset of portions,
wherein the encoder is configured to identify and retrieve, in response to receiving the message from the control block, at least one portion of the subset of portions from the buffer using the index numbers in the message, and to encode subsequent portions of the video signal using the at least one retrieved portion.

13. The system of claim 12 wherein the portions of the video signal are (i) frames of the video signal, (ii) macroblocks of the video signal, or (iii) slices of the video signal.

14. The system of claim 12 wherein the encoder comprises means for transmitting the portions of the video signal over the network to the decoder and for transmitting the index numbers as side information accompanying the transmitted portions of the video signal to which they are allocated.

15. The system of claim 12 wherein the encoder is one of a H.264 encoder, a VP7 encoder and a VP8 encoder.

16. The system of claim 12 wherein there is one of a network connection and a USB connection between the encoder and the control block for transmitting the message.

17. The system of claim 12 wherein the encoder is situated in a user terminal and the control block is situated in either (i) a receiving node of the network in which the decoder is also situated, or (ii) a separate network node.

18. The system of claim 12 wherein the control block is situated in a user terminal and the encoder is situated in a peripheral device of the user terminal.

19. The system of claim 18 wherein the peripheral device is a camera.

20. A method of controlling transmission of portions of a video signal which are encoded by an encoder and transmitted over a network to a decoder, wherein the encoder allocates index numbers to the transmitted portions of the video signal and stores at least some of the portions of the video signal in a buffer associated with the encoder, each index number identifying a respective portion of the video signal, the method comprising:
receiving feedback from the network at a control block remote from the encoder, the feedback indicating whether each of the transmitted portions has been correctly received;
based on the feedback, the control block determining a subset of the portions of the video signal stored in the buffer which are to be used by the encoder for encoding subsequent portions of the video signal; and
the control block transmitting a message to the encoder, said message identifying the subset of portions of the video signal using the index numbers allocated to the portions in the subset of portions,
such that the encoder can use the index numbers in the message to identify at least one portion of the subset of portions for encoding subsequent portions of the video signal.

21. A computer program product comprising computer readable instructions for execution by computer processing means at a control block remote from the encoder for controlling transmission of portions of a video signal which are encoded by an encoder and transmitted over a network to a decoder, wherein the encoder allocates index numbers to the transmitted portions of the video signal and stores at least some of the portions of the video signal in a buffer associated with the encoder, each index number identifying a respective portion of the video signal, the instructions comprising instructions for:
receiving feedback from the network, the feedback indicating whether each of the transmitted portions has been correctly received;
based on the feedback, determining a subset of the portions of the video signal stored in the buffer which are to be used by the encoder for encoding subsequent portions of the video signal; and
transmitting a message to the encoder, said message identifying the subset of portions of the video signal using the index numbers allocated to the portions in the subset of portions,
such that the encoder can use the index numbers in the message to identify at least one portion of the subset of portions for encoding subsequent portions of the video signal.

22. A control block for controlling transmission of portions of a video signal which are encoded by an encoder and transmitted over a network to a decoder, wherein the encoder allocates index numbers to the transmitted portions of the video signal and stores at least some of the portions of the video signal in a buffer associated with the encoder, each index number identifying a respective portion of the video signal, wherein the control block is remote from the encoder and the control block comprises:
receiving means for receiving feedback from the network, the feedback indicating whether each of the transmitted portions has been correctly received;
determining means for determining, based on the feedback, a subset of the portions of the video signal stored in the buffer which are to be used by the encoder for encoding subsequent portions of the video signal; and
transmitting means for transmitting a message to the encoder, said message identifying the subset of portions of the video signal using the index numbers allocated to the portions in the subset of portions,
such that the encoder can use the index numbers in the message to identify at least one portion of the subset of portions for encoding subsequent portions of the video signal.

23. The control block of claim 22 wherein the transmitting means is for transmitting the message to the encoder via one of a network connection and a USB connection between the control block and the encoder.

24. A control block configured to control transmission of portions of a video signal which are encoded by an encoder and transmitted over a network to a decoder, wherein the encoder allocates index numbers to the transmitted portions of the video signal and stores at least some of the portions of the video signal in a buffer associated with the encoder, each index number identifying a respective portion of the video signal, wherein the control block is remote from the encoder and the control block comprises:
a receiver configured to receive feedback from the network, the feedback indicating whether each of the transmitted portions has been correctly received;
a determining block configured to determine, based on the feedback, a subset of the portions of the video signal stored in the buffer which are to be used by the encoder for encoding subsequent portions of the video signal; and
a transmitter configured to transmit a message to the encoder, said message identifying the subset of portions of the video signal using the index numbers allocated to the portions in the subset of portions,
such that the encoder can use the index numbers in the message to identify at least one portion of the subset of portions for encoding subsequent portions of the video signal.
